(19) United States
(12) Patent Application Publication
(10) Pub. No.: US 2023/0309534 A1
(43) Pub. Date: Oct. 5, 2023

(54) Equine Shoe with Concave Topside

(71) Applicant: Monty L. Ruetenik, Clear Lake Shores, TX (US)

(72) Inventor: Monty L. Ruetenik, Clear Lake Shores, TX (US)

(21) Appl. No.: 18/094,216

(22) Filed: Jan. 6, 2023

Related U.S. Application Data
(60) Provisional application No. 63/327,319, filed on Apr. 4, 2022.

(51) Int. Cl. A01L 3/02

(52) U.S. Cl. CPC A01L 3/02

(57) ABSTRACT

An equine shoe structure and assembly that provides a cushioning effect on the equine hoof and legs, covers substantially all the underside of a hoof, and provides an upper concave surface shaped to mate with a rounded shaped equine hoof.

### CROSS-REFERENCE TO RELATED APPLICATION

This application claims the benefit and priority from U. S. Provisional Patent Application, filed, the contents and disclosure of both are incorporated herein by reference for all purposes.

### BACKGROUND

### Field of Invention

This invention relates to equine shoes. More specifically, it relates to an equine shoe structure and assembly that provides a cushioning effect on the hoof and legs, covers substantially all the underside of a hoof, provides an upper concave surface shaped to mate with a rounded shaped equine hoof.

### Background

Equine with laminitis or other diseases or abnormalities of the hoof require special hoof treatment. When an equine suffers laminitis, the lamina of the hoof is weakened and the position of the coffin bone seems to shift from its normal of parallel to the ground to an angled position. In fact, it is believed that the coffin bone does not actually shift but that the hoof shifts due to the weakened lamina. The shift of the position of the coffin bone is very damaging and often fatal to an equine.

Generally, correction of the shift and relief for the equine may be accomplished by proper trimming of the hoof and/or special rocker shoes (or attachments to shoes) or boots that reposition the hoof/coffin bone positions.

It has been found that trimming the hoof to a rounded shape (as by trimming to toe and heel) and attachment of a rocker shoe is especially effective in repositioning the coffin bone/hoof positions and gives very positive results.

What is needed is an equine shoe having an upper concave shape to mate with the rounded shape of a trimmed equine hoof. The present invention provides such a shaped shoe and a method of constructing such a shoe.

### SUMMARY OF INVENTION

This invention is an equine, dual density, hoof shaped polymer shoe that generally covers the substantially the entire underside of a hoof. The shoe is sloped on the underside to allow the hoof to roll forward, or to the side, without unnecessary bending, thus allowing an equine to find a comfortable natural position to relieve stress on a sore, injured or diseased hoof. The structure is dual density polymer construction (having a top and a bottom section of differing densities) with a relatively narrow hard section on the top section and a thicker softer section below, the harder component attaches to the hoof and acts to stabilize the softer lower section. Copper or other solid medical components may be bonded into the top side (side in contact with the hoof when in use).

The topside of the solid structures is formed into a concave structure shaped to mate with a rounded under-surface of an equine hoof, the rounded shape formed in the hoof to provide a rocker shape to reposition the slope of the coffin bone. The rounded shape of the hoof is formed by trimming the hoof to a shape determined by observing a radiograph image of the hoof to allow a desired repositioning of the coffin bone. It has been found advantageous to shape the underside of an equine hoof, particularly if the hoof is diseased with laminitis, to ideally position the slope of the coffin bone to its natural position parallel to the ground. The position of the coffin bone is determined by observing radiographs of the hoof. Rounding the underside of the hoof, and attaching an equine shoe with a concave top surface that mates with the round shape of the hoof allows precise location of the coffin bone to achieve both comfort and healing relief for a laminitic equine hoof. The hoof (and attached shoe) may be rounded front to back but also side to side to correct any misalignment of the hoof and coffin bone. There are significant advantages when a hoof is so rounded and combined with a rocker bottom shoe.

The invention is also a structure to shape the topside of a polymeric equine shoe.

### DESCRIPTION OF THE DRAWINGS

FIG. 1 is a front view of a polymer shoe of an embodiment of the invention with a flat normal upper side with an angle monitor.

FIG. 2 is a side of a polymer shoe of an embodiment of the invention with a concave upper side.

FIG. 3 is another side view of a polymer shoe of an embodiment of the invention with a concave upper side.

FIG. 4 is another side view of a polymer shoe of an embodiment of the invention with a shallower concave upper side.

FIG. 5 is side view of a polymer shoe of an embodiment of the invention that has been overheated.

FIG. 6 is a top perspective view of a device to produce a concave top side in a polymer shoe of an embodiment of the invention.

FIG. 7 is another perspective top view of a device to produce a concave top side in a polymer shoe of an embodiment of the invention.

### DETAILED DESCRIPTION OF THE INVENTION

The shoes of this invention are dual density (different densities of a top section and a bottom section) polymer shoes such as those described in U.S. Pat. No. 10,548,304 issued Feb. 4, 2020. Shoes such as those described in FIG. 1A, through 3A of the patent are especially useful as are the shoe described in U.S. D897,052 issued Sep. 22, 2020. The shoes are there described as an solid, dual density, hoof shaped shoe structure designed to substantially cover the entire underside of a hoof.

The shoe is sloped on the underside to allow the hoof to roll forward, or to the side, without unnecessary bending, thus allowing an equine to find a comfortable natural position to relieve stress on a sore, injured or diseased hoof. The structure is dual density construction with a relatively thin hard section on the top section and a thicker softer section below. The harder section attaches to the hoof and acts to stabilize the softer lower section. Copper or other solid medical components may be bonded into the top side (side in contact with the hoof when in use). The disclosure and drawings of U.S. Pat. No. 10,548,304 issued Feb. 4, 2020 and U.S. D897,052 issued Sep. 22, 2020 are incorporated herein by reference for all purposes.

In the present invention the top side of the solid structures as described above are shaped to form a concave structure shaped to mate or conform with a rounded undersurface of an equine hoof. It has been found to be advantageous to shape the underside of an equine hoof, particularly if the hoof is diseased with laminitis, to ideally position the equine coffin bone relative to the ground and provide for a “rocker” action that allows the hoof to rotate with less stress. The position of the coffin bone is determined by observing radiographs of the hoof to determine an optimum position of the coffin bone. Rounding the underside of the hoof, and attaching a polymer shoe with a concave upper side (positioned next to the underside of the rounded hoof) facilitates achieving a precise location of the coffin bone to provide both comfort a but healing relief fora laminitic equine hoof.

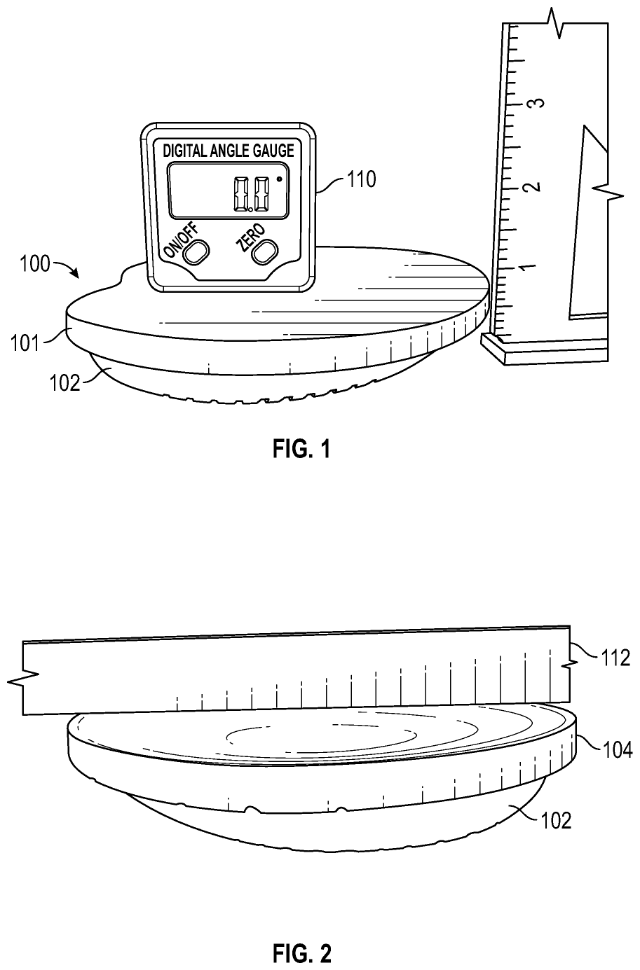

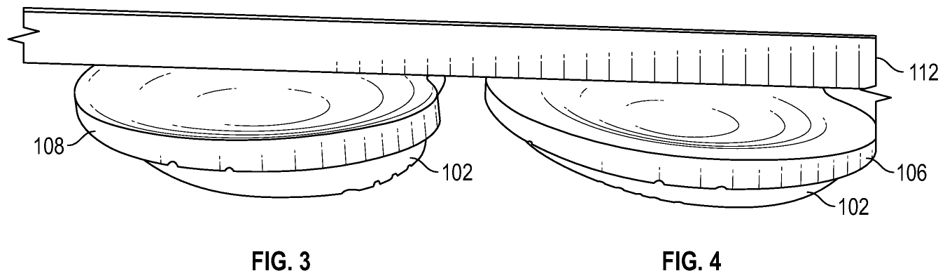

Referring to the drawings and pictures, FIG. 1 is a picture of a polymer shoe of an embodiment of the invention with a normal flat top side. FIGS. 2, 3 and 4 are pictures of shoes of embodiments of the invention showing a concave topside, the depth of the concave being greater in FIGS. 2 and 3 from that in FIG. 4. This is to illustrate that the concave depth as well as its shape and location on the topside of the shoe are flexible and may be positioned as desired. Generally, the depth and location of the concave shape will be determined by reference to a radiograph image of the hoof to achieve optimum repositioning of the coffin bone of a hoof with a mis-located coffin bone.

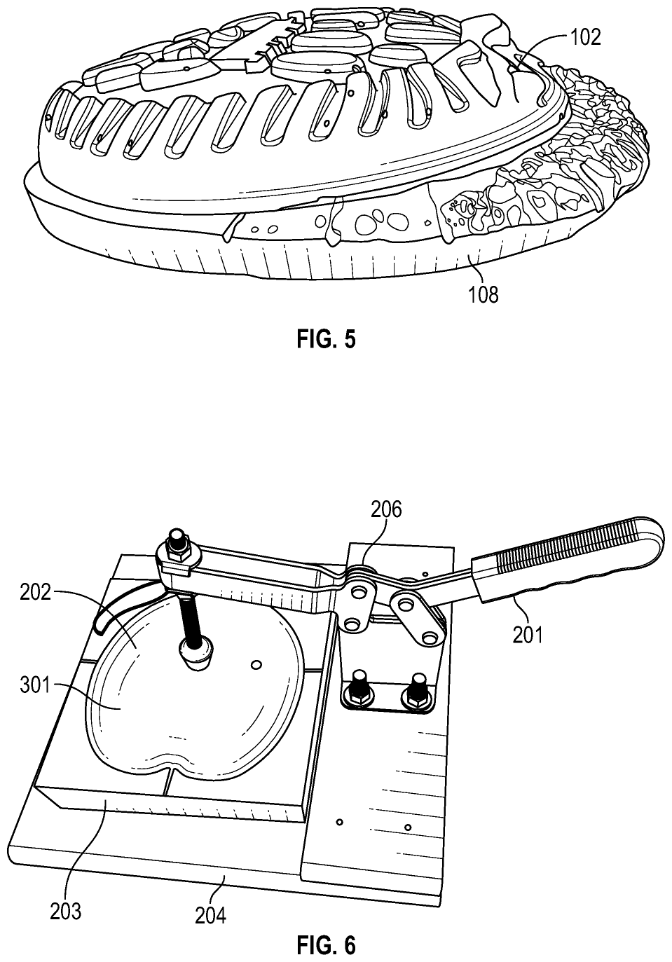

In one embodiment, for polyurethane shoes of a composition as described in U.S. Pat. No. 10,548,304 issued Feb. 4, 2020, the shoe is heated to about 300° F. to soften the hard polymer top section of the shoe. FIG. 5 shows the result of overheating the shoe, in one case to 350° F. The center section of the topside can then be pressed downward to form the desired concave shape. To shoe is then quickly cooled to set the shape, as by submerging it in a water bath (preferably a cooled water bath). The degree of heating of other polymer composition necessary to soften the topside for shaping can be easily determined by those skilled in the art, by prior knowledge or by trial and error.

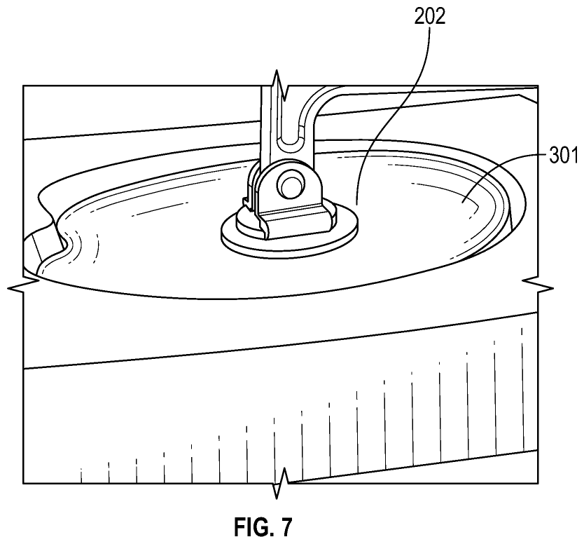

FIGS. 6, 7 and 8 illustrate a device that is useful for forming the desired concave shape in the shoe topside. The device consists of a base with a recessed area of a shape to receive a polymer shoe. There is an adjustable levered arm with a section containing a plunger so that when the lever is activated, the plunger presses down on the topside of a heated shoe that is positioned in the recessed area. The lever and device is constructed in such a way that the plunger can be positioned in any desired part of the topside of the shoe and can be fixed in place when the desired shape is formed.

In operation, a polymer shoe is heated to a desire temperature, placed in the recessed area of the device and the plunger activated to push the desired shape into the topside of the shoe and the entire device with the shoe is submerged in a water bath to quickly cool the heated shaped shoe and thus fix the concave shape in the topside of the shoe.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. An equine polymer shoe having a top section and a bottom section wherein the top section has a concave shape formed into it.

2. The equine shoe of claim 1 wherein the concave shape is designed to mate with a rounded bottom side of an equine hoof.

3. The equine shoe of claim 1 where the polymer is polyurethane.

4. A device having a base with a recessed section shaped to receive a heated equine shoe and a lever with a plunger constructed so that the plunger may be used to press a section of the topside of a hearted equine shoe located in the recessed section to a desired depth and shape.

5. A method of shaping the topside of a polymer shoe having a topside and a bottom side comprising:
a. heating to a malleable point but not melted;
b. pressing a area of the topside to form a concave shape;
c. rapidly cooling the shoe so shaped to fix the shape.

6. The method of claim 5 where the equine shoe is polyurethane.
